(19) United States
(12) Patent Application Publication
(10) Pub. No.: US 2026/0364402 A1
(43) Pub. Date: Nov. 19, 2026

(54) CONTEXTUAL FITNESS ACTIVITY FEEDBACK FOR ELECTRONIC DEVICES

(71) Applicant: Apple Inc., Cupertino, CA (US)

(72) Inventors: Florent THOMAS-MOREL, San Diego, CA (US); Alexander R. LEDWITH, Santa Cruz, CA (US); Joel J. ANGELONE, Carlsbad, CA (US); Tu K. NGUYEN, Fountain Valley, CA (US); Vincent M. CHAN, Cupertino, CA (US); Yazan F. HALAWA, San Francisco, CA (US); You REN, Merced Island, WA (US); Daniel S. KEEN, San Jose, CA (US)

(21) Appl. No.: 19/408,319

(22) Filed: Dec. 3, 2025

Related U.S. Application Data
(60) Provisional application No. 63/808,547, filed on May 19, 2025.

(51) Int. Cl. A63B 24/00; A63B 71/06; G06N 20/00

(52) U.S. Cl. CPC A63B 24/0062; A63B 24/0006; A63B 71/0622; G06N 20/00; A63B 2024/0009; A63B 2024/0065; A63B 2071/063

(57) ABSTRACT

In order, for example, to provide efficient, intelligent, conversation-style feedback to a user regarding fitness-related activities of the user with, for example, a resource-limited device, such as a smart watch, the device may pre-compute and pre-cache aggregated fitness results at the device. The aggregated fitness results may include distinct sets of aggregated fitness results for distinct user interface features. The device may embed a particular set of the aggregated fitness results, for a particular user interface feature, in a human-language prompt, in prose, that is provided to a large language model (LLM) or large multimodal model (LMM). A human-language response, in prose, from the LLM or LMM may be received at the device and output as, for example, an audio output from a speaker of the device or in a user interface of the device or a companion device.

### CROSS REFERENCE TO RELATED APPLICATIONS

This application claims the benefit of priority to U.S. Provisional Patent Application No. 63/808,547, entitled, “Contextual Fitness Activity Feedback for Electronic Devices”, filed on May 19, 2025, the disclosure of which is hereby incorporated herein in its entirety.

### TECHNICAL FIELD

The present description generally relates to machine learning, including, for example, contextual fitness activity feedback for electronic devices.

### BACKGROUND

Wearable fitness trackers often track a user’s movements while wearing the wearable fitness tracking, and provide step counts or a distance walked each day to the user.

### BRIEF DESCRIPTION OF DRAWINGS

Certain features of the subject technology are set forth in the appended claims. However, for purpose of explanation, several embodiments of the subject technology are set forth in the following figures.

FIG. 1 illustrates an example network environment in accordance with one or more implementations of the subject technology.

FIG. 2 illustrates an example device in accordance with one or more implementations of the subject technology.

FIG. 3 illustrates an example of an example of an electronic device providing contextual fitness activity feedback in accordance with one or more implementations of the subject technology.

FIG. 4 illustrates another example of an electronic device providing contextual fitness activity feedback in accordance with one or more implementations of the subject technology.

FIG. 5 illustrates an example of a companion device performing operations for providing contextual fitness activity feedback in accordance with one or more implementations of the subject technology.

FIG. 6 illustrates another example of an electronic device providing contextual fitness activity feedback in accordance with one or more implementations of the subject technology.

FIG. 7 illustrates a flowchart of an example process that may be performed by a portable electronic device for providing contextual fitness activity feedback in accordance with one or more implementations of the subject technology.

FIG. 8 illustrates a flowchart of an example process that may be performed by a companion device for providing contextual fitness activity feedback in accordance with one or more implementations of the subject technology.

FIG. 9 illustrates a flowchart of an example process that may be performed by an application for controlling an electronic device to perform a process in accordance with one or more implementations of the subject technology.

FIG. 10 illustrates a flowchart of another example process that may be performed by an application for controlling an electronic device to perform a process in accordance with one or more implementations of the subject technology.

FIG. 11 illustrates a device in accordance with one or more implementations of the subject technology.

FIG. 12 illustrates a system in accordance with one or more implementations of the subject technology.

FIG. 13 illustrates a ladder diagram corresponding to the operations of FIG. 9 in accordance with one or more implementations of the subject technology.

FIG. 14 illustrates a ladder diagram corresponding to the operations of FIG. 10 in accordance with one or more implementations of the subject technology.

FIG. 15 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

In accordance with aspects of the disclosure, systems and processes are disclosed that may automatically and electronically provide efficient, intelligent, conversation-style feedback to a user regarding fitness-related activities of the user. In order, for example, to provide efficient, intelligent, conversation-style feedback to a user regarding fitness-related activities of the user with, for example, a resource-limited device, such as a smart watch, the device may pre-compute and pre-cache aggregated fitness results at the device. The aggregated fitness results may include distinct sets of aggregated fitness results for distinct user interface features (e.g., a motivational voices user interface feature or other user interface feature). A human-language prompt, in prose, may be generated, within which the device may embed a dataset including a particular set of the aggregated fitness results, for a particular user interface feature. The human-language prompt, in prose, within which the particular set of aggregated fitness results is embedded, may be provided (e.g., by the device or a companion device) to a large language model (e.g., in a private cloud computing (PCC) system). A human-language response, in prose, from the large language model may be received at the device and output as, for example, an audio output from a speaker of the device (e.g., for a motivational voices user interface feature) or in a user interface of the device or a companion device.

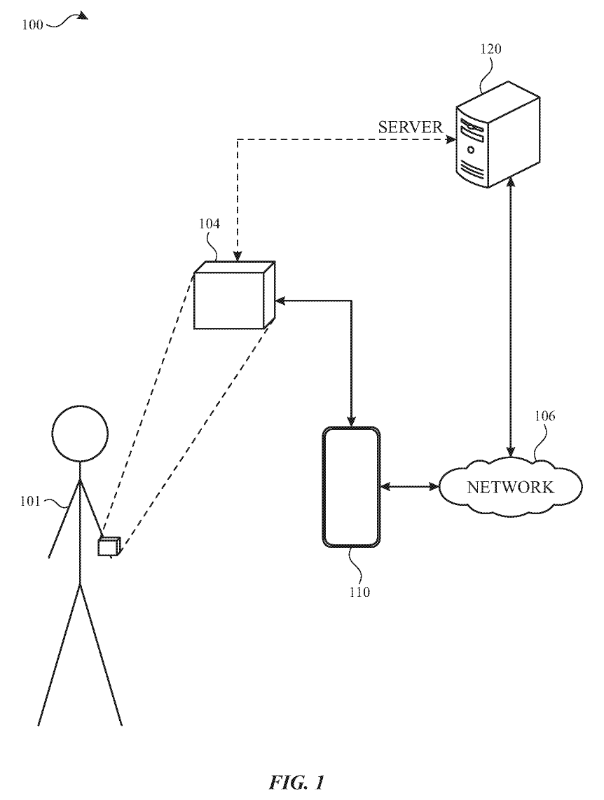

FIG. 1 illustrates an example network environment 100 in accordance with one or more implementations of the subject technology. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 104 (also referred herein to as a computing device or a portable electronic device), an electronic device 110 (also referred herein to as a computing device), and a server 120. The network 106 may communicatively (directly or indirectly) couple the electronic device 104, the electronic device 110, and/or the server 120. In one or more use cases, the electronic device 104 may communicate directly with the electronic device 110 (e.g., without using the network 106). In one or more implementations, the network 106 may be an interconnected network of devices that may include, or may be communicatively coupled to, the Internet. For explanatory purposes, the network environment 100 is illustrated in FIG. 1 as including the electronic device 104, the electronic device 110, and the server 120; however, the network environment 100 may include any number of electronic devices and any number of servers.

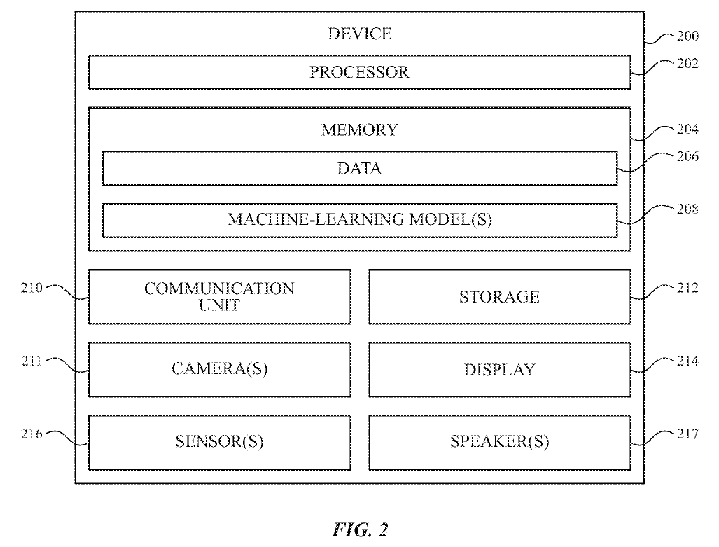

The electronic device 104 may be, for example, a portable electronic device, such a smartphone, a tablet device, or a wearable device such as a smart watch, a peripheral device (e.g., headphones or earbuds), a head mountable device (HMD), a smart band, a smart ring, or the like. In FIG. 1, by way of example, the electronic device 104 is depicted as a smart watch that is worn by a user 101 on the user’s wrist. In this example, one or more sensors of the electronic device 104 may be contact with and/or in close proximity to the skin of the user 101, and may be able to sense biometric signals from the user’s skin and/or blood that is present within or beneath the skin. In this way, the electronic device 104 may be able to obtain activity information for the user 101, such as a heartrate, a heartrate range, a blood oxygen level, a breathing rate, or the like. The electronic device 104 may also include motion sensors (e.g., an inertial measurement unit (IMU)) that can sense motion of the electronic device 104, and thereby motion of the user 101 (e.g., for determining when the user makes a particular motion, such as taking a walking step or a running step). The electronic device 104 may be, and/or may include all or part of, the systems discussed below with respect to FIGS. 2, 11, and/or 15.

The electronic device 110 may be, for example, a desktop computer, a portable computing device such as a laptop computer, a smartphone, a peripheral device (e.g., a digital camera, headphones), a tablet device, a wearable device such as a smart watch or a head mountable device (HMD), a smart band, a smart ring, and the like. In FIG. 1, by way of example, the electronic device 110 is depicted as a smartphone, which may be operated as a companion device for the electronic device 104 (e.g., while the electronic device 104 and the electronic device 110 are pair and/or communicatively coupled, such as via a wireless connection). The electronic device 110 may include more computing resources (e.g., processing power, memory, and/or electrical power) in comparison with the electronic device 104. The electronic device 110 may be, and/or may include all or part of, the systems discussed below with respect to FIGS. 2, 11, and/or 15.

In one or more implementations, the electronic device 104 and/or the electronic device 110 may provide a system for training a machine learning model using training data, where the trained machine learning model is subsequently deployed locally at the electronic device 104 and/or the electronic device 110. Further the electronic device 104 and/or the electronic device 110 may provide one or more frameworks for training machine learning models and/or developing applications using the machine learning models. In an example, the electronic device 104 may be a wearable device that includes one or more sensors that are capable of capturing biometric information from a user and/or one or more speakers that are capable of outputting a computer-generated audio signal. In one or more implementations as described herein, the electronic device 104 and/or the electronic device 110 may communicate with a server 120 (e.g., a cloud server, which may provide private cloud computing technology), such as to obtain responses from a large language model (LLM) or large multimodal model (LMM) at the server 120. In one or more other implementations as described herein, an application (e.g., and/or one or more user interface features of one or more applications) at the electronic device 104 and/or the electronic device 110 may communicate with an operating system of the electronic device 104 and/or the electronic device 110, such as to obtain raw, pre-processed, pre-cached, and/or aggregated activity data, such as fitness data.

In an implementation, the server 120 may train one or more machine learning models for deployment locally at the server and/or for deployment to a client electronic device (e.g., the electronic device 104 or the electronic device 110). In other implementations, the server 120 may provide a system for training a machine learning model using training data, where the trained machine learning model is subsequently deployed locally at the server 120. The machine learning model may be deployed on the server 120 and/or the electronic device 110 may then perform one or more machine learning algorithms. In one or more implementations, the server 120 may provide a cloud service that utilizes the trained machine learning model and is continually refined over time. The server 120 may be, and/or may include all or part of, the systems discussed below with respect to FIGS. 2, 11, and/or 15.

FIG. 2 illustrates an example device 200 in accordance with one or more implementations of the subject technology. The device 200 may be an implementation of the electronic device 104, the electronic device 110, or the server 120.

As shown, the device 200 may include a processor 202, memory 204 (memory device), and a communication circuitry 210. The memory 204 may store data 206 and one or more machine learning models 208. In an example, the device 200 may include or may be communicatively coupled with a storage 212. The storage 212 may be an internal storage or an external storage. In the example of FIG. 2, the device 200 includes one or more cameras 211, a display 214, one or more sensors 216, and one or more speakers 217. Camera(s) 211 may be operable to capture images, and may be mounted on a front surface, a rear surface, or any other suitable location on the electronic device 104 or electronic device 110 of FIG. 1. The display 214 may be operable to display a user interface of an application, and/or display content. Sensor(s) 216 may include location sensors (e.g., satellite positioning system sensors), motion sensors (e.g., inertial sensors such as accelerometers, gyroscopes, and/or magnetometers, which may be incorporated in an inertial measurement unit (IMU)), depth sensors (e.g., stereo cameras, LIDAR sensors, radar sensors, time-of-flight sensors, or the like), acoustic sensors (e.g., microphones), biometric sensors (e.g., heart sensors, an electrocardiogram (ECG) sensor, a photoplethysmography (PPG) sensor, a blood oxygen sensor, a blood pressure sensor), temperature sensors, pressure sensors, touch sensors, and/or other sensors (e.g., other sensors for sensing the state and/or activity of a user of the electronic device 104 and/or the electronic device 110).

In an example, the processor 202 may include a single processing unit or multiple processing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable instructions and data stored in the memory 204.

The memory 204 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The data 206 may represent, amongst other things, a repository of data processed, received, and generated by one or more processors such as the processor 202. One or more of the aforementioned components of the device 200 may send or receive data, for example, using one or more input/output ports and one or more communication units.

The machine learning model(s) 208, in an example, may include one or more of machine learning based models and artificial intelligence-based models, such as, for example, neural networks, or any other models and/or machine learning architectures. In an example, the machine learning model(s) 208 may be trained using training data (e.g., included in the data 206 or other data) and may be implemented by the processor 202 for performing one or more of the operations, as described herein. In an example, the communication circuitry 210 may include one or more hardware units that support wired or wireless communication between the processor 202 and processors of other computing devices.

The machine learning model(s) 208 may include one or more machine learning models that are trained to identify patterns, events, and/or aggregated results from activity data (e.g., fitness data) obtained in real time using the sensor(s) 216 and stored in the memory 204. One or more of the machine-learning models may be configured generate human-language text, in prose, for a prompt to be provided to another machine learning model (e.g., a large language model) at another device, such as the server 120. In one or more implementations, one or more of the machine learning model(s) 208 may be trained as large language models and/or large multimodal models. For example, a large language model may be formed by training a neural network, such as a transformer model, that has thousands, hundreds of thousands, millions, billions, or trillions of tunable parameters to generate human language responses, in prose, to human language prompts, in prose. Training the neural network may include adjusting the tunable parameters of the neural network based on comparisons of output training data (e.g., including hundreds, thousands, millions, billions, or trillions of words, phrases, sentences, paragraphs, and/or pages of human language text in one or more human languages, such as English, Spanish, French, Chinese, etc.) with training outputs of the neural network, the training outputs generated responsive to training input prompts in the one or more human languages.

FIG. 3 is a block diagram of the electronic device 104, illustrating various operations that may be performed by the electronic device 104 operations for providing intelligent activity feedback (e.g., fitness activity) feedback for a user. Various portions of the architecture of FIG. 3 can be implemented in software, firmware, and/or hardware, including by one or more processors and a memory device containing instructions, which when executed by the processor cause the processor to perform the operations described herein. For example, in FIG. 3, the rectangular boxes may indicate that the sensor(s) 216, the communication circuitry 210, the storage 300, a cache 304, the speaker 217, and the display 214 may be hardware components, and the trapezoidal boxes may indicate that one or user interface (UI) features, a pre-processing and pre-caching block 302, a prompt generator 310, and a speech generator 312 may be implemented in software, including by execution of instructions by one or more processors (e.g., processor 202 of FIG. 2) and a memory device (e.g., memory 204) containing the instructions, which when executed by the processor cause the processor to perform the operations described herein.

As shown in FIG. 3, one or more sensor signals from one or more sensors 216 may be obtained by the electronic device 104 and provided to a pre-processing and pre-caching block 302. The sensor signals may be generated by the sensor(s) 216 during performance, by the user 101, of an activity (e.g., a fitness activity, such as a workout, which may include a run, a walk, a high intensity interval training (HIIT) activity, a row, a weights workout, an elliptical workout, a dance, a hike, a climb, a volleyball game, or the like).

Sensor signals obtained from the sensor(s) 216, and/or activity (e.g., fitness) metrics (e.g., steps, heartrate, distance travelled, split time, elevation gained, etc.) generated based on the sensor signals, during an activity of the user may be referred to as “live” or “real-time” activity (e.g., fitness) information. After an activity has been completed, the activity information for that activity may be stored in storage 300 of the electronic device 104. Activity information that is stored (e.g., in the storage 300) after the activity is completed may be referred to herein as “historical” activity information for the user 101. The historical activity information may include activity information (e.g., heart rates, step counts, distances walked, distances run, distances cycled, distances swum, split times, etc.) obtained over a historical period extending days, weeks, months, or years prior to a current time. In one or more implementations, the storage 300 may also store activity information for one or more people, other than the user 101, that are associated with the user (e.g., friends or family members that have given permission for their activity data to be stored and/or accessed by the electronic device 104) in the storage 300. In one or more implementations, some or all of the historical activity information may be stored at one or more other devices that have more storage capability than the electronic device 104, such as the electronic device 110 and/or a cloud server, such as the server 120.

In one or more implementations, one or more user interface features, such as a UI feature 306 (e.g., UI Feature 1 in FIG. 3) and a UI feature 308 (e.g., UI Feature 2 in FIG. 3), may be configured to provide human language feedback to a user regarding their current and/or historical activity (e.g., physical activity or fitness activity). For example, the UI feature 306 may be a spoken-word feature that outputs a computer-generated voice using one or more speakers 217 of the electronic device 110. As another example, the UI feature 308 may display human-language feedback, in prose, using a display 214 of the electronic device 110. As indicated in the figure, the electronic device 110 may include one or more other UI features, which may include a user query feature, in which an end user of the electronic device 110 can prompt (e.g., by a providing spoken or typed prompt in prose via a microphone, display, or keyboard of the electronic device) the electronic device 110 to provide audio and/or display feedback in conversational human language form (e.g., by speaking a question about the user’s activity to be received by one or more microphones of the electronic device).

Machine learning models, such as large language models (LLMs) and/or large multi-modal models (LMMs) have been developed that are trained to generate human language text responsive to human language requests or prompts. These machine learning models may be able to generate the human language feedback. However, because the live activity data and the historical activity data at the electronic device 104 is dynamic (e.g., on time scales of seconds, to minutes, to hours), a LLM or LMM itself may be unable to generate the type of activity-specific outputs that would make human-language activity feedback relevant and/or interesting to a user (e.g., because incorporating the live and/or historical fitness data into the training of the model itself would take longer than the duration during which the live and/or historical fitness data remains interesting and relevant to the user).

For example, it may take days or weeks to update the training of a large language model to incorporate new results into the model’s outputs. However, feedback about a user’s activities may, in some use cases, only remain relevant for a few seconds, minutes, or hours (e.g., during a workout, within a few seconds or reaching a workout milestone, or within a minutes or hours of recent workouts). Moreover, it can be difficult or impossible to implement a LLM or LMM on a resource-constrained device, such as a smart watch or a smartphone. Accordingly, challenges arise in being able to provide an electronic device with the ability to present human-language feedback with respect to user activity (e.g., within a time period of the relevancy of the feedback to the user), particularly with devices that are resource constrained (e.g., due to being physically small enough to be worn or carried by a user during the activity).

Aspects of the subject technology can provide efficient, intelligent, conversation-style feedback to a user regarding fitness-related activities of the user in a way that addresses these challenges, and thereby improves the functioning of a computing device, beyond what the device would be capable of in the absence of integration of the subject technology in the computing device. For example, as shown in FIG. 3, the electronic device 104 may include a pre-processing and pre-caching block 302 that pre-processes the live and/or historical activity information to generate aggregated results (e.g., aggregated fitness results, or aggregated activity results) that can be pre-cached (e.g., stored, prior to usage by a UI feature) in a cache 304 at the electronic device 104. For example, the cache 304 may store one or more sets of aggregated fitness results for one or more respective user interface features of the portable electronic device. For example, the cache 304 may store a set 305 of aggregated activity results for the UI feature 306 and a set 307 of aggregated activity results of the UI feature 308. The data in the sets 305 and 307 may be entirely separate in some use cases, or the cache 304 may include some data that belongs to both sets 305 and 307 in some use cases. The sets 305 and 307 may be stored in connection with (e.g., labeled for) the UI features 306 and 308 respectively, or the sets 305 and 307 may be stored in the cache 304 without being identified, in the cache, as being associated with the UI features 306 and 308 (e.g., even if the sets 305 and 307 were generated responsive to query information received, respectively, from the UI features 306 and 308). For example, the UI feature 306 and the UI feature 308 may each provide respective (e.g., and different) query information to the pre-processing and pre-caching block 302. The pre-processing and pre-caching block 302 may generate the aggregated activity results for each UI feature based on the respective query information received for that UI feature.

The UI feature 306 may be configured to generate computer-generated human-language audio feedback at various stages of an activity (e.g., at the start of the activity, at various progress points, such as split times, during the activity, upon completion of user-specified goals, upon occurrence of one or more milestones or breakthroughs during the activity, and/or at the end of the activity. As one example of computer-generated human-language audio feedback, the UI feature 306 may generate congratulatory computer-generated human-language audio feedback when various activity milestones are achieved by the user (e.g., during performance of an activity by the user). For example, the milestones may be reached when the live activity data from the sensor(s) 216 indicates a significant deviation (e.g., a three-sigma deviation, five-sigma deviation, ten-sigma deviation, a factor of two deviation, a factor of ten deviation, a highest-ever deviation, a longest-ever deviation, a fastest-ever deviation, etc.) from corresponding historical activity data information. As examples, the milestones may include a user’s longest distance (e.g., run, biked, walked, swum, climbed, rowed, hiked, etc.), fastest time (e.g., a fastest split time, such as a fasted mile, half mile, five kilometers, marathon, half marathon, etc.), or first performance (e.g., ever, or in a new location) of an particular activity (e.g., a run, walk, cycle, swim, hike, dance, row, HIIT, Muay Thai, Thai Chi, climb, etc.). As another example of computer-generated human-language audio feedback, the UI feature 306 may generate motivational computer-generated human-language audio feedback. As examples, motivational computer-generated human-language audio feedback may be generated at or near the start of an activity (e.g., as a pep talk to motivate the user), when milestone is reached (e.g., to encourage the user to reach a next milestone), when a milestone is imminent (e.g., to encourage the user to continue on to the milestone), or at the end of an activity (e.g., to leverage the user’s successful completion of the activity to motivate future activities). Other examples of computer-generated human-language audio feedback are also contemplated herein, including conversational computer-generated human-language audio feedback or summarizing computer-generated human-language audio feedback that present activity information, statistics, milestones, results, breakthroughs, and/or the like to the user in conversational manner that incorporates the context of the day, time, environment, media output, weather, and/or other features of the user’s experience around the activity.

Determining (e.g., in order to determine when to trigger congratulatory, motivational, conversational, summarizing, and/or other computer-generated human-language audio feedback) whether a milestone has been reached, determining whether a milestone is imminent, determining how a milestone compares with prior milestones, and/or gathering relevant information at the start or end of an activity may require specific computations on, and/or queries to, the historical activity data in the storage 300. However, querying the historical activity data in the storage 300 for particular features and/or combinations of the historical activity data each time a milestone is reached in the live activity data, each time a milestone is imminent, each time an activity starts or ends, and/or each time a comparison with the historical activity data is desired for detecting a milestone, may require several seconds or minutes of computation. As discussed herein, this type of time-consuming query to the storage 300 may prevent the electronic device 104 from providing desired congratulatory computer-generated human-language audio feedback within a time frame in which the feedback is relevant to the user.

In order, for example, to reduce the latency in providing computer-generated human-language audio feedback with the electronic device 104, the UI feature 306 may provide query information to the pre-computing and pre-caching block 302, the query information requesting that historical milestone data (e.g., a current distance, time, type, and/or location of a current activity, and historical longest, fastest, and/or first activity information) be pre-computed and pre-cached in the cache 304. Responsive to receiving the query information, the pre-processing and pre-caching block 302 may pre-populate the cache 304 with the requested information for the UI feature 306 (e.g., by computing and/or aggregating activity results related to the current distance, time, type, and/or location of the current activity, and/or the historical longest, fastest, and first activity information in the historical activity data, into the set 305 of aggregated activity results for the UI feature 306). In this way, the activity-specific information to be included in congratulatory computer-generated human-language audio feedback can be pre-computed (e.g., prior to being used by the UI feature 306) and pre-cached in the cache 304. This can significantly reduce (e.g., from several minutes or hours down to one or several seconds) the time for the electronic device 110 to obtain the relevant activity information for the UI feature 308 when a milestone is reached that triggers generation of a congratulatory human-language audio feedback of the UI feature 306.

As another example, the UI feature 308 may be another user interface feature that is configured to provide congratulatory or encouraging computer-generated text for display and/or audio output (e.g., in and/or by a UI of a fitness application running at the electronic device 104). For example, the UI feature 308 may generate congratulatory or encouraging computer-generated text for display and/or audio output responsive to different events and/or triggers (e.g., user queries and/or longer term accumulated milestones or achievements) than those that trigger the UI feature 306 to generate computer-generated audio outputs. In one or more implementations, an activity-goal completion day for a current week and one or more prior weeks, and/or an average activity-goal completion day may be pre-computed and pre-cached in the set 307 in the cache 304. For example, query information from UI feature 308 may include queries for current and historical goal completions, and/or other information (e.g., times, locations, media output) associated with goal completion(s), for each of one or more activity goals. Responsive to this query information from the UI feature 308, the pre-processing and pre-caching block 302 may compute and aggregate the queried information into the set 307 of aggregated activity results for the UI feature 308.

In one or more implementations, the set 305 and the set 307 of the aggregated activity results may include additional information, such as a location (e.g., a city, state, country, road, street, or the like) at which one or more activities referenced in the set 305 and/or the set 307 occurred, a time (e.g., a time of day, a day of the week, a month, a season, a year) at which one or more activities referenced in the set 305 and/or the set 307 occurred, weather information (e.g., temperature, wind, precipitation, UV index, etc.) during one or more activities referenced in the set 305 and/or the set 307, and/or information indicating music or other media output by the electronic device 104, the electronic device 110 during one or more activities referenced in the set 305 and/or the set 307.

As shown in FIG. 3, the electronic device 104 may include a prompt generator 310. For example, the sets 305 and 307 of aggregated activity results may include statistics, numbers, locations, times, music, etc., without any linking or descriptive text. As discussed herein, one option for providing activity feedback would be to insert the aggregated activity results into pre-generated text for audio and/or visual notifications. However, in order, for example, to enhance the conversational and/or insightful characteristics of the activity feedback, the prompt generator may embed some or all of the set 305 (e.g., in the form of a data context, such as context1 in the figure) in a human-language prompt, in prose, to be provided to a LLM or LMM (e.g., at a remote device or system, such as the server 120). For example, the prompt may be human-language text, in prose (e.g., “Here is the user’s activity context: [contex1], including a split milestone reached by the user. Generate a short congratulatory message for the user.”) in which the context is embedded (e.g., in brackets, [], in this example) in the human-language text.

In some examples, the activity context may include information about the split milestone and/or other activity information from the time that the split milestone was reached (e.g., a number, N, of calories burned at the time that the split milestone was reached, an average number, P, of beats per minute of the user’s heart at the time that the split milestone was reached, media content that was playing at time that the split milestone was reached, a location of the user at the time that the split milestone was reached, weather conditions at the time that the split milestone was reached, etc.). The prompt may be generated in response to a prompt request from the UI feature 306, or the prompt generator 310 may monitor the cache 304 for triggering events (e.g., workout starts, milestones, progress points, goal achievements, workout ends, or the like) and generate a prompt when a triggering event is detected.

In one or more implementations, the prompt generator 310 may populate pre-generated prompt text for a particular event with the context information. In one or more other implementations, the prompt generator 310 may be a machine learning model or a rules-based process that is configured (e.g., trained, in the case of the machine learning model) to generate the prompt text (e.g., customized for the activity context and/or an event).

As shown in FIG. 3, the prompt may be provided for transmission, by the communication circuitry 210, to a remote device or system, such as the electronic device 110 and/or the server 120. The remote device or system may have an LLM or LMM that has been trained to generate human-language responses, in prose, to human language prompts, in prose, generated by the electronic device 110. For example, in response to the example prompt above, the response from the LLM or LMM at the remote system may include computer-generated human-language text, in prose, such as “You've completed the first split. N calories burned and an average heartrate of P beats per minute. Keep it up!”, where N and P are numbers obtained from the activity context. In one or more use cases, the LLM or LMM may select the numbers N and P for inclusion in the response, such as from among one or more additional activity features included in the activity context in the prompt.

In one or more use cases, if the activity context included information that the electronic device was outputting media content, such as a song, “song”, by an artist, “artist”, at the time the milestone (e.g., the split first split in this example) was reached, the response may include additional text generated by the LLM or LMM, such as: “Looks like ‘Song Title’ by “Artist” really helped to motivate you to reach this split faster than usual!”

As shown, once the response has been received by the electronic device 104, the response may be provided to a speech generator 312 at the electronic device 104. For example, the speech generator 312 may generate an output signal that represents a computer-generated voice speaking the response text in the response. As shown, the output signal may be provided to the UI feature 306 for which the prompt was generated, and the UI feature 306 may provide the output signal to the speaker 217 for output. For example, when output by the speaker 217, the output signal may cause the speaker 217 to generate sound corresponding to the computer-generated voice speaking the response text in the response.

In one or more implementations, in order, for example, to provide the computer-generated audio feedback in a conversational manner, the prompt and/or the activity context may include information indicating and/or referencing prior prompts and/or responses between the electronic device 104 and the remote device that includes the LLM or LMM. In this way, the LLM or LMM can generate subsequent responses that are aware of, reference, and/or update prior responses that have been output by the UI feature 306. For example, when a subsequent split is reached after the first split in the example above, a subsequent response from the LLM or LMM may be “Another split down! You’ve burned 34 calories so far with an average heart rate of 134 beats per minute. This is down a bit from your last split – keep up the energy!” In this way, the remote LLM or LMM can allow the electronic device 104 to interact with the user’s ongoing activity in a way that would be difficult or impossible with pre-programmed text that is not adaptable to changing circumstances and/or events. It is appreciated that the pre-processing and pre-caching block 302 facilitates the integration of a remote LLM or LMM (e.g., larger than can be stored and/or executed by the electronic device 104) into the generation of activity feedback in a way that avoids latencies (e.g., due to data querying overhead on top of the use of the remote LLM or LMM) that could otherwise render the UI feature 306 or the UI feature 308 less relevant to the user of the electronic device 104.

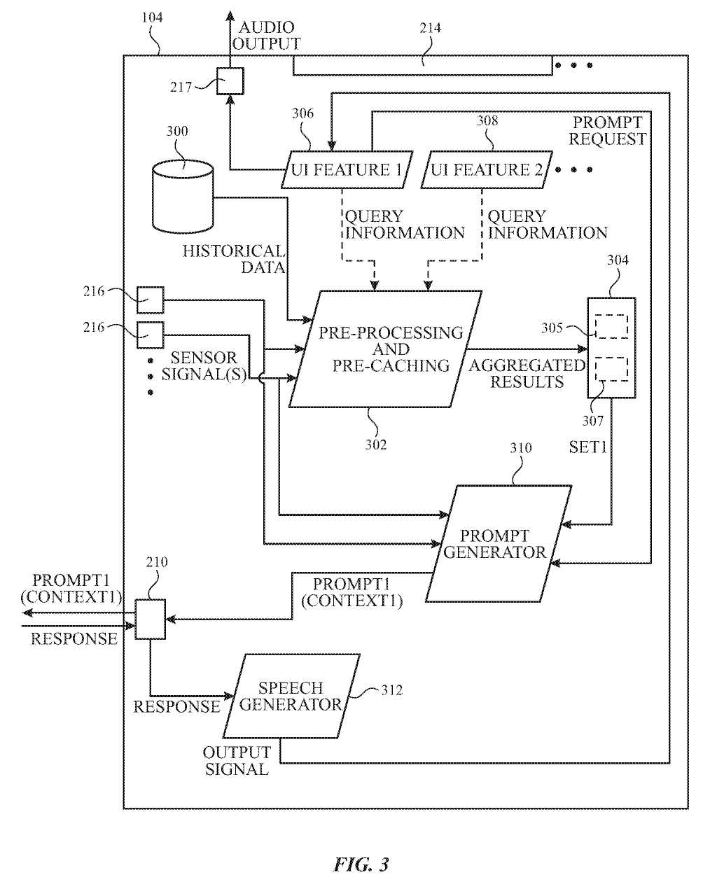

In the example of FIG. 3, the electronic device 104 includes a speech generator 312 that generates an audio signal from text in a response received from an LLM or LMM. In one or more other implementations, the audio signal may be generated by the LLM or LMM itself, and/or by an intervening device, before the response is received by the electronic device 104. For example, FIG. 4 illustrates a use case in which the electronic device 104 does not include a speech generator. In the example of FIG. 4, responsive to the prompt, the electronic device 104 receives (e.g., at the communication circuitry 210) an audio response signal that (e.g., after decoding of a wireless transmission carrying the audio response signal) can be provided directly to the UI feature 306 for output by the speaker 217. In one or more implementations, the audio response signal may be generated by a companion device of the electronic device 104, such as the electronic device 110.

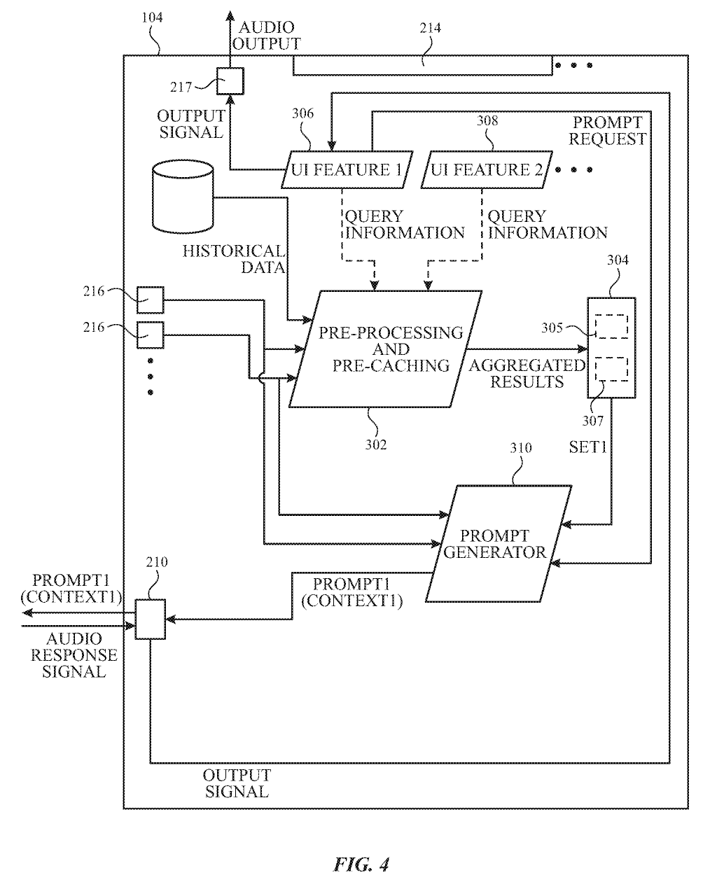

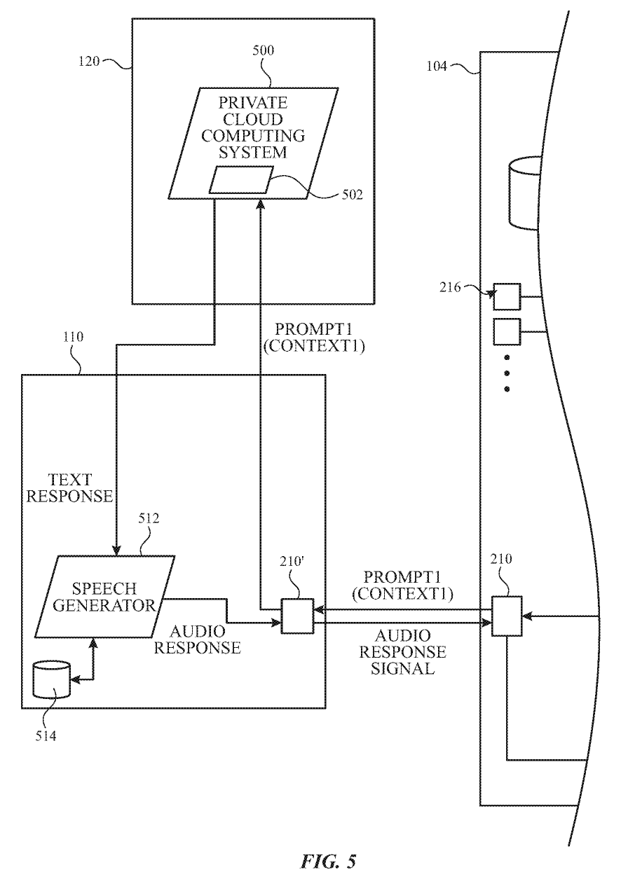

For example, FIG. 5 illustrates an example implementation in which the prompt generated by the prompt generator 310 of FIG. 4 is transmitted (e.g., directly, such as via a Bluetooth, NFC, Thread, or direct WIFI signal) from the communication circuitry 210 of the electronic device 104 to communication circuitry 210’ of the electronic device 110 (e.g., while the electronic device 104 and the electronic device 110 are paired and have established a wireless connection therebetween). As shown, the electronic device 110 may transmit the prompt (e.g., over a wired and/or wireless connection, such as a network connection that includes the network 106 of FIG. 1) to a remote system, such as the server 120.

In the example of FIG. 5, the server 120 hosts a machine learning model 502, which may be trained as a large language model (LLM) or large multimodal model (LMM) as described herein. In one or more implementations, the machine learning model 502 may be implemented in a private cloud computing (PCC) system 500 (e.g., in order to protect the privacy, such as from export from the server and/or viewing or access by a provider of the server, of any user-specific information that may be received in the prompt and/or in the activity context received in the prompt).

As shown, responsive to receiving the prompt, machine learning model 502 may generate a text response (e.g., “You've completed the first split. N calories burned and an average heartrate of P beats per minute. Keep it up!”, as in the example above), and provide the text response to the electronic device 110. In the example of FIG. 5, the text response received at the electronic device 110 may be provided to a speech generator 512 at the electronic device 110. The speech generator 512 may generate an audio response (e.g., audio data that, when output by a speaker, causes the speaker to generate sound corresponding to a computer-generated voice audibly speaking the text in the text response). In one or more implementations, the electronic device 110 may include, or have access to, a voice database 514. For example, the voice database 514 may store voice attributes (e.g., tone, timbre, cadence, etc.) of one or more specific voices of one or more specific people. For example, the people for which the voice attributes may be stored may include friends or family members of a user of the electronic device 110 that have given their explicit permission to have their voice attributes used for generation of activity feedback, and/or one or more trainers or coaches of the user (e.g., trainers or coaches that participate in video activity guidance, such as in workout videos, that is accessible via the electronic device 110 and/or the electronic device 104). In this way, the speech generator 512 may be provided with the ability to generate audio responses in one or more voices that are familiar to the user of the electronic device 110 and/or the electronic device 104 (e.g., familiar in the context of physical activities and/or workouts).

As discussed herein, the aggregated activity results that are stored in the cache 304 may include sets of results that are relevant to multiple different user interface features at the electronic device 104. FIG. 6 illustrates another use case in which a prompt (e.g., Prompt2) is generated, by the prompt generator 310, for another UI feature (e.g., UI feature 308). As shown, the prompt in FIG. 6 may include a different activity context (e.g., context2) that is based on a different set (e.g., SET2, such as the set 307) of aggregated activity results. In one or more implementations, prompt generation for the UI feature 308 may be triggered by a prompt request from the UI feature 308, or may be triggered on a periodic basis. This may be in contrast, for example, to sensor-data triggered prompts for the UI feature 306.

As shown in the example of FIG. 6, the prompt including the different activity context may be transmitted (e.g., by the communication circuitry 210) to a remote system or device (e.g., the electronic device 110 and/or the server 120, as discussed herein in connection with FIGS. 4 and 5). Responsive to the prompt that includes the different activity context, the electronic device 104 may receive a different response (e.g., a human language response, in prose, such as in text form), and may generate a different output signal for the UI feature 308. In this example, the UI feature 308 generates display content, for display by the display 214, the display content including the text in the response to the second prompt.

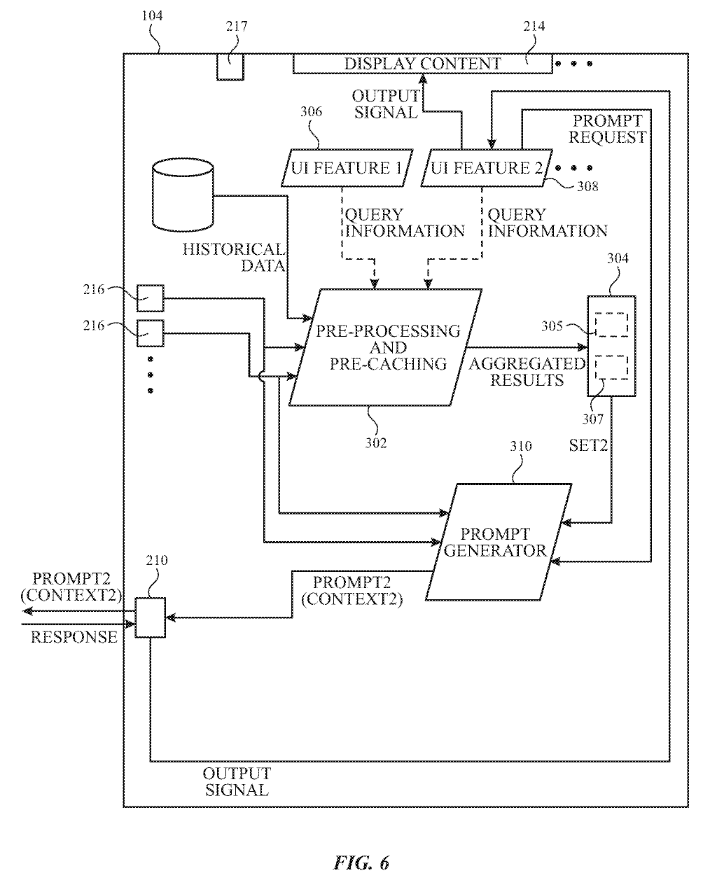

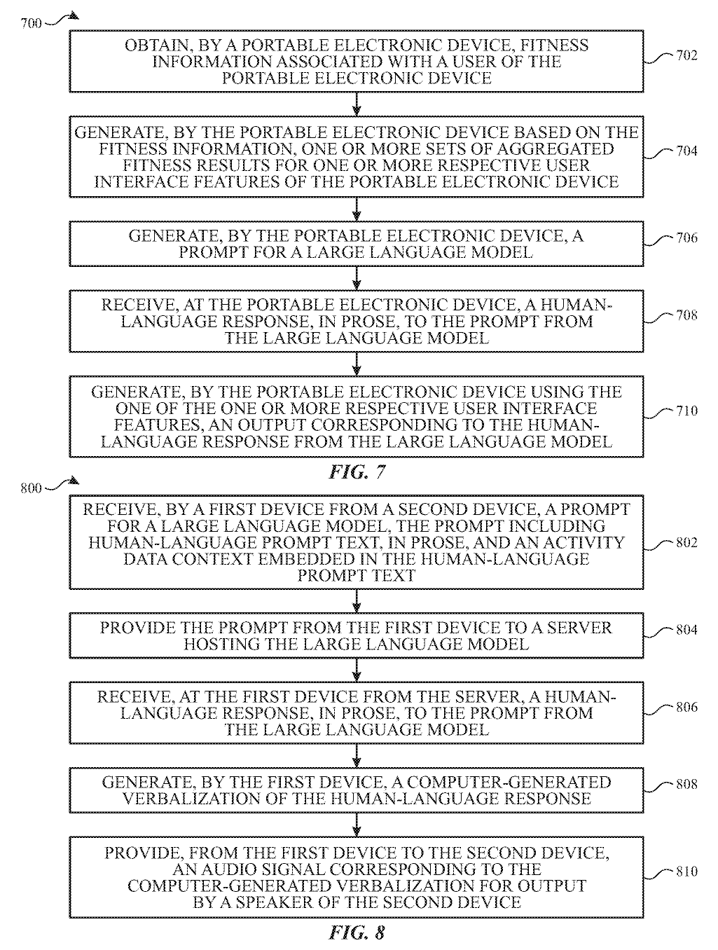

FIG. 7 is a flow diagram of an example process 700 for providing contextual fitness activity feedback by an electronic device, in accordance with one or more implementations. For explanatory purposes, the process 700 is primarily described herein with reference to the electronic device 104 of FIG. 1. However, the process 700 is not limited to the electronic device 104, and one or more blocks (or operations) of the process 700 may be performed by one or more other components and/or other suitable devices (e.g., the electronic device 110 and/or the server 120). Further for explanatory purposes, the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

At block 702, a portable electronic device (e.g., electronic device 104) may obtain fitness information associated with a user (e.g., user 101) of the portable electronic device. Obtaining the fitness information may include obtaining “live” fitness information being generated by (e.g., and/or based on) sensor signals from one or more sensors (e.g., sensor(s) 216) of the portable electronic device during performance of an activity, such as a fitness activity, by a user of the portable electronic device. Obtaining the fitness information may include obtaining historical activity information for the user from storage (e.g., storage 300) at the portable electronic device or another device (e.g., a companion device).

At block 704, the portable electronic device (e.g., pre-processing and pre-caching block 302) may generate (e.g., as described herein in connection with FIG. 3), based on the fitness information, one or more sets (e.g., sets 305 and 307) of aggregated fitness results for one or more respective user interface features (e.g., UI features 306 and 308) of the portable electronic device.

At block 706, the portable electronic device (e.g., prompt generator 310) may generate a prompt (e.g., Prompt1 or Prompt2 as discussed in connection with FIGS. 4-6) for a large language model (e.g., machine learning model 502). The prompt may include human-language (e.g., English, Spanish, French, Chinese, Hindi, Italian, etc.) prompt text, in prose, and a context (e.g., context1 or context 2, as discussed in connection with FIGS. 4-6) embedded in the human-language prompt text. The context may correspond to (e.g., may be the same as or may be a packaged version of some or all of) one of the one or more sets of aggregated fitness results for one of the one or more respective user interface features.

At block 708, the portable electronic device may receive, from the large language model (e.g., from the LLM directly or via a companion device, such as the electronic device 110), a human-language response, in prose, to the prompt. The response may be received from a device or system (e.g., server 120) hosting the large language model or from an intervening device or system, such as a companion device (e.g., as in the example of FIG. 5).

At block 710, the portable electronic device may generate (e.g., by operating an output component, such as the speaker 217 or the display 214) using the one of the one or more respective user interface features, an output (e.g., an audio output or display content) corresponding to the human-language response from the large language model.

In one or more implementations, the one of the one or more respective user interface features includes an audio user interface feature (e.g., UI feature 306), and the output includes an audio output from a speaker (e.g., speaker 217) of the portable electronic device. The audio output may include a computer-generated verbalization (e.g., generated by the speaker responsive to an output signal generated by the speech generator 312) of the human-language response, in prose, from the large language model. For example, the computer-generated verbalization may be generated in a computer-generated voice that includes one or more voice characteristics (e.g., stored in a voice database 514 at the portable electronic device or a companion device) of a voice of a specific human fitness trainer that is associated with (e.g., one or more workout videos previously viewed by) the user of the portable electronic device.

In one or more implementations, the fitness information may include live fitness data being generated by a sensor (e.g., one or more of sensor(s) 216) of the portable electronic device during performance of an activity (e.g., a workout) by the user. The one of the one or more sets of the aggregated fitness results may include at least some of the live fitness data, and generating the prompt at block 706 may include generating the prompt responsive to an event associated with at least one of the activity or the live fitness data. In one or more implementations, the event may include a start of the activity, an end of the activity, or a milestone event in (e.g., or indicated by) the live fitness data. The one of the one or more sets of the aggregated fitness results may also include historical fitness data (e.g., from the storage 300) for the user. The event may include the milestone event in the live fitness data, and the human-language response to the prompt from the large language model may include a congratulatory message (e.g., “You've completed the first split. N calories burned and an average heartrate of P beats per minute. Keep it up!”) corresponding to the milestone event.

In one or more use cases, the portable electronic device may also generate, responsive to a subsequent milestone event in the live fitness data, a subsequent prompt for the large language model, the subsequent prompt including additional human-language prompt text and an updated context, corresponding to the one of the one or more sets of aggregated fitness results for the one of the one or more respective user interface features, embedded in the additional human-language prompt text. The portable electronic device may receive a subsequent human-language response to the subsequent prompt from the large language model the subsequent human-language response including text (e.g., “Another split down! You’ve burned 34 calories so far with an average heart rate of 134 beats per minute. This is down a bit from your last split – keep up the energy!”) corresponding to the milestone event and the subsequent milestone event. The portable electronic device may generate, using the one of the one or more respective user interface features, a subsequent output corresponding to the subsequent human-language response from the large language model.

In one or more implementations, the one of the one or more sets of aggregated fitness results may also include an indicator of media content (e.g., a song, an artist, etc.) output by (e.g., a speaker and/or a display of) the portable electronic device or another device (e.g., electronic device 110 or an audio device, such as earbuds or headphones) of the user during the activity, and the human-language response to the prompt from the large language model may include text (e.g., “Looks like ‘Song Title’ by ‘Artist’ really helped to motivate you to reach this split faster than usual!”) corresponding to the event and the media content.

In one or more implementations, generating the one or more sets of aggregated fitness results for the one or more respective user interface features of the portable electronic device may include periodically generating the one or more sets of aggregated fitness results for the one or more respective user interface features of the portable electronic device.

In one or more implementations, the process 700 may also include providing (e.g., transmitting over a wired or wireless connection) the prompt to a companion device (e.g., electronic device 110) for transmission to a server (e.g., server 120) storing the large language model, and receiving the human-language response from the companion device. For example, the companion device may relay the prompt to the server, and relay a response from the server (e.g., or an audio signal or other processed signal generated by the companion device based on the response) to the portable electronic device. As examples, the portable electronic device may include a smart watch and the companion device may include a smartphone (e.g., a paired with and connected to the smart watch via a wireless connection).

In one or more implementations, the one of the one or more respective user interface features may include a user interface (e.g., UI feature 308) of a fitness application for display by a display (e.g., display 214) of the portable electronic device, and the output may include displayed text (e.g., display content in FIG. 6), corresponding to the human-language response from the large language model, in the user interface of the fitness application. For example, the fitness information may include historical fitness information for the user over a first period of time (e.g., weeks, months, or years), and the human-language response from the large language model may include text that refers to one or more fitness achievements (e.g., milestones or breakthroughs) of the user within a second period of time (e.g., minutes or hours) shorter than the first period of time.

In accordance with aspects of the subject technology, a portable electronic device may be provided that includes a memory and one or more processors configured to: obtain activity information associated with a user of the portable electronic device; generate, based on the activity information, one or more sets of aggregated activity results for one or more respective user interface features of the portable electronic device; generate a prompt for a machine learning model that has been trained to generate prose responses to prose prompts, the prompt comprising prompt text, in prose, and a context embedded in the prompt text, the context corresponding to one of the one or more sets of aggregated activity results for one of the one or more respective user interface features; receive, at the portable electronic device, a response, in prose, to the prompt from the machine learning model; and generate, by the portable electronic device using the one of the one or more respective user interface features, an output corresponding to the response from the machine learning model.

The portable electronic device may also include a speaker, the one of the one or more respective user interface features may include an audio user interface feature, and the output may include an audio output from the speaker, the audio output including a computer-generated verbalization of the response, in prose, from the machine learning model. The portable electronic device may also include a sensor, the activity information may include activity data being generated by the sensor during performance of an activity by the user, the one of the one or more sets of the aggregated activity results may include at least some of the activity data, and generating the prompt may include generating the prompt responsive to an event associated with at least one of the activity or the activity data. The event may include a start of the activity, an end of the activity, or a milestone event in the activity data. The one of the one or more sets of the aggregated activity results may also include historical activity data for the user, the event may include the milestone event in the activity data, and the response to the prompt from the machine learning model may include a congratulatory message corresponding to the milestone event. The one or more processors may be further configured to generate, responsive to a subsequent milestone event in the activity data, a subsequent prompt, in prose, for the machine learning model, the subsequent prompt including additional prompt text and an updated context, corresponding to the one of the one or more sets of aggregated activity results for the one of the one or more respective user interface features, embedded in the additional prompt text; receive a subsequent response, in prose from the machine learning model, to the subsequent prompt, the subsequent response including text corresponding to the milestone event and the subsequent milestone event; and generate, using the one of the one or more respective user interface features, a subsequent output corresponding to the subsequent response from the machine learning model.

In accordance with aspects of the subject technology, a non-transitory computer readable medium may be provided storing instructions of an application (e.g., a fitness application) for controlling an electronic device to perform a process, the process including: obtaining, by a portable electronic device, fitness information associated with a user of the portable electronic device; generating, by the portable electronic device based on the fitness information, one or more sets of aggregated fitness results for one or more respective user interface features of the portable electronic device; generating, by the portable electronic device, a prompt for a large language model, the prompt comprising human-language prompt text, and a context embedded in the human-language prompt text, the context corresponding to one of the one or more sets of aggregated fitness results for one of the one or more respective user interface features; receiving, at the portable electronic device, a human-language response to the prompt from the large language model; and generating, by the portable electronic device using the one of the one or more respective user interface features, an output corresponding to the human-language response from the large language model.

At block 802, a first device (e.g., electronic device 110) may receive, from a second device (e.g., electronic device 104), a prompt for a large language model (e.g., machine learning model 502). The prompt may include human-language prompt text, in prose, and an activity data context embedded in the human-language prompt text. For example, the activity data context may correspond to one of one or more sets (e.g., sets 305 or 307) of aggregated fitness results for one of one or more respective user interface features (e.g., UI feature 306 or UI feature 308) at the second device.

At block 804, the prompt may be provided (e.g., relayed, such as via a network) from the first device to a server (e.g., server 120) hosting the large language model.

At block 806, the first device may receive, from the server (e.g., via the network), a human-language response, in prose, to the prompt from the large language model.

At block 808, the first device (e.g., speech generator 512) may generate a computer-generated verbalization of the human-language response (e.g., an audio response, as in the example of FIG. 5).

At block 810, the first device may provide, to the second device, an audio signal (e.g., audio response signal, as in the example of FIG. 5) corresponding to the computer-generated verbalization for output by a speaker (e.g., speaker 217) of the second device.

In one or more use cases, the aggregated fitness results may be based on real-time sensor data obtained by one or more sensors (e.g., sensor(s) 216) of the second device immediately before (e.g., within seconds or a minute of) the receiving of the prompt, and the process 800 may also include, by the first device: generating another prompt, in prose, for the large language model, the other prompt including additional prompt text and another context that is based on historical activity data at the first device, the other context corresponding to another set of aggregated activity results for a user interface feature at the first device, embedded in the additional prompt text; providing the other prompt to the server; receiving another response, in prose from the large language model, to the other prompt; and generating, using the user interface feature at the first device, another output (e.g., including display content corresponding to prose text in the other response) corresponding to the other response from the large language model.

Aspects of the subject technology may provide fitness intelligence UI features, such as motivational voices and/or other UI features. As described herein, underlying these UI features may be a system to pre-process and pre-cache information (e.g., activity information) in a database (e.g., a health database). Because querying the health database on demand may be difficult or impossible to perform in a timely manner, the activity information may be pre-processed and pre-cached (e.g., in the form of aggregated fitness results) The health database may be crawled and cached to facility timely computations and/or queries against the pre-cached data. For example, a device may pre-compute values with respect to various time frames. In one or more implementations, a machine learning model that generates human-language text, in prose, for one or more UI features may select and/or filter the activity information provided (e.g., in an activity context) with a prompt to the machine learning model. For example, the machine learning model may find two or three facts that are estimated to be most interesting to tell the user about, and incorporate those two or three facts into the human-language text generated by the machine learning model. Prompts may be provided to the machine learning model for generating outputs for a user based on a milestone or breakthrough (e.g., a new largest deviation from the user’s historical data and/or patterns) and/or based on a start or end of an activity, and may integrate information about the milestone or breakthrough and/or the start or end of the activity into the human-language text to present to a user via, for example, the motivational voices UI feature and/or other UI features.

As described above, one aspect of the present technology is the gathering and use of data available from specific and legitimate sources for providing contextual fitness activity feedback

. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user’s health or level of fitness (e.g., vital signs measurements, medication information, exercise information, activity information, fitness information, fitness activity information), media output information, dietary data, date of birth, or any other personal information.

The present disclosure recognizes that the use of such personal information data, in the present technology, can be used to the benefit of users. For example, the personal information data can be used for providing contextual fitness activity feedback. Accordingly, use of such personal information data may facilitate transactions (e.g., on-line transactions). Further, other uses for personal information data that benefit the user are also contemplated by the present disclosure. For instance, health and fitness data may be used, in accordance with the user’s preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of providing contextual fitness activity feedback, the present technology can be configured to allow users to select to "opt in" or "opt out" of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing identifiers, controlling the amount or specificity of data stored (e.g., collecting location data at city level rather than at an address level), controlling how data is stored (e.g., aggregating data across users), and/or other processes such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

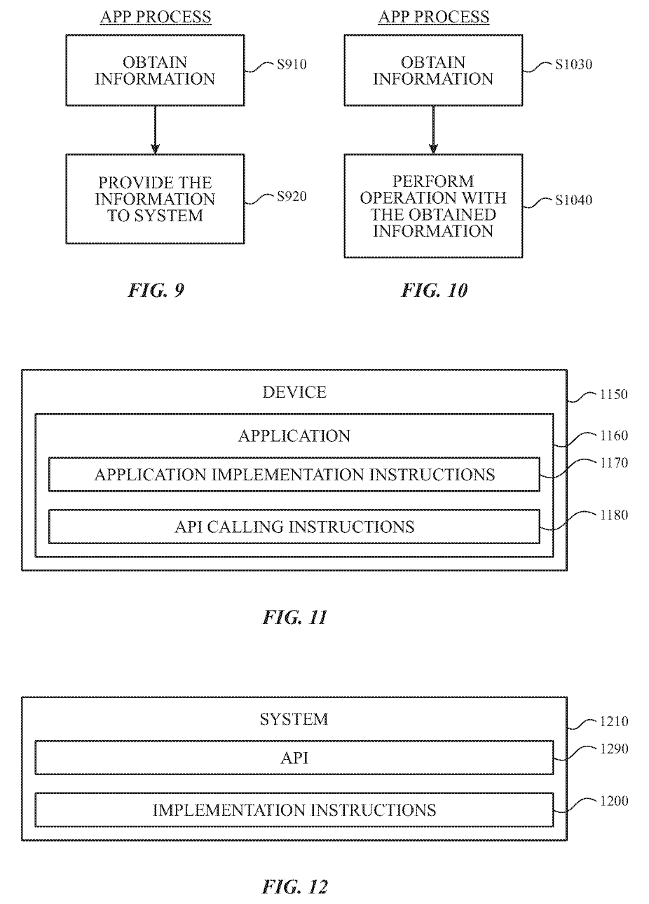

Implementations within the scope of the present disclosure include a computer-readable storage medium that encodes instructions organized as an application (e.g., application 1160 of FIG. 11) that, when executed by one or more processing units, control an electronic device (e.g., device 1150 of FIG. 11) to perform the process of FIG. 12, the process of FIG. 9, the process of FIG. 10, and/or one or more other processes and/or processes described herein.

It should be recognized that application 1160 (shown in FIG. 11) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 1160 is an application that is pre-installed on device 1150 at purchase (e.g., a first party application). In other embodiments, application 1160 is an application that is provided to device 1150 via an operating system update file (e.g., a first party application or a second party application). In some embodiments, application 1160 is an application that is provided via an application store. In some embodiments, the application store can be an application store that is pre-installed on device 1150 at purchase (e.g., a first party application store). In some embodiments, the application store is a third-party application store (e.g., an application store that is provided by another application store, downloaded via a network, and/or read from a storage device).

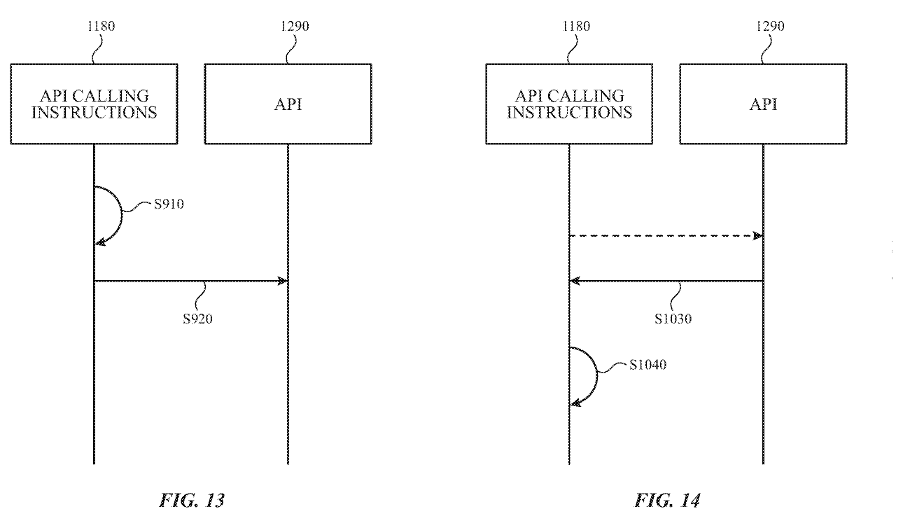

Referring to FIGS. 9 and 13, application 1160 obtains information (e.g., S910). In some embodiments, at S910, information is obtained from at least one hardware component of the device 1150. In some embodiments, at S910, information is obtained from at least one software module (e.g., set of instructions) of the device 1150. In some embodiments, at S910, information is obtained from at least one hardware component external to the device 1150 (e.g., a peripheral device, an accessory device, and/or a server). In some embodiments, the information obtained at S910 includes positional information, time information, image information, activity information, sensor information, prompt information, notification information, user information, environment information, electronic device state information, weather information, media information, historical information, event information, hardware information, and/or motion information. In one or more implementations, the information obtained at S910 may include live and/or historical activity data, aggregated activity results, activity context, a prompt, or a response to a prompt. In some embodiments, in response to and/or after obtaining the information at S910, application 1160 provides the information to a system (e.g., S920).

In some embodiments, the system (e.g., system 1210 shown in FIG. 12) is an operating system hosted on the device 1150. In some embodiments, the system (e.g., system 1210 shown in FIG. 12) is an external device (e.g., a server, a peripheral device, a companion device, an accessory, and/or a personal computing device) that includes an operating system.

Referring to FIGS. 10 and 14, application 1160 obtains information (e.g., S1030). In some embodiments, the information obtained at S1030 includes positional information, time information, activity information, prompt information, prompt response information, notification information, ranking information, user information, environment information, electronic device state information, weather information, media information, historical information, event information, hardware information and/or motion information. In one or more implementations, the information obtained at S1030 may include live and/or historical activity data, aggregated activity results, activity context, a prompt, or a response to a prompt. In one or more implementations, the information obtained at S1030 may include an output generated by a machine learning system in response to receiving an input. In one or more implementations, the information obtained at S1030 may be obtained in response to providing first information (e.g., live and/or historical activity information and/or an activity content) to an operating system (e.g., at S920). In response to and/or after obtaining the information at S1030, application 1160 performs an operation with the information (e.g., S1040). In some embodiments, the operation performed at S1040 includes: generating one or more sets of aggregated results based on the information, providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 1210 based on the information. In one or more implementations, the operation performed at S1040 includes one or more of the operations described herein in connection with FIGS. 3-8. For example, performing the operation at S1040 may include providing contextual fitness activity feedback from an electronic device.

In some embodiments, one or more steps of the process of FIG. 9 and/or the process of FIG. 10 is performed in response to a trigger. In some embodiments, the trigger includes detection of an event, a notification received from system 1210, a user input, and/or a response to a call to an API provided by system 1210.

In some embodiments, the instructions of application 1160, when executed, control device 1150 to perform the process of FIG. 9 and/or the process of FIG. 10 by calling an application programming interface (API) (e.g., API 1290) provided by system 1210. In some embodiments, application 1160 performs at least a portion of the process of FIG. 9 and/or the process of FIG. 10 without calling API 1290.

In some embodiments, one or more steps of the process of FIG. 9 and/or the process of FIG. 10 includes calling an API (e.g., API 1290) using one or more parameters defined by the API. In some embodiments, the one or more parameters include a constant, a key, a data structure, an object, an object class, a variable, a data type, a pointer, an array, a context, a list or a pointer to a function or process, and/or another way to reference a data or other item to be passed via the API.

Referring to FIG. 11, device 1150 is illustrated. In some embodiments, device 1150 is a personal computing device, a smart phone, a smart watch, a fitness tracker, a smart ring, a head mounted display (HMD) device, a media device, a communal device, a speaker, a television, and/or a tablet. Device 1150 includes application 1160 and an operating system (not shown) (e.g., system 1210 shown in FIG. 12). Application 1160 includes application implementation instructions 1170 and API-calling instructions 1180. System 1210 includes API 1290 and implementation instructions 1200. It should be recognized that device 1150, application 1160, and/or system 1210 can include more, fewer, and/or different components than illustrated in FIG. 11 and 12.

In some embodiments, application implementation instructions 1170 is a software module that includes a set of one or more computer-readable instructions. In some embodiments, the set of one or more instructions of instructions 1170 correspond to one or more operations performed by application 1160. For example, when application 1160 is a messaging application, application implementation instructions 1170 can include operations to receive and send messages. In some embodiments, application implementation instructions 1170 communicates with API calling instructions to communicate with system 1210 via API 1290 (shown in FIG. 12).

In some embodiments, API-calling instructions 1180 is a software module that includes a set of one or more computer-executable instructions.

In some embodiments, implementation instructions 1200 is a software module that includes a set of one or more computer-executable instructions.

In some embodiments, API 1290 is a software module that includes a set of one or more computer-executable instructions. In some embodiments, API 1290 provides an interface that allows a different set of instructions (e.g., API-calling instructions 1180) to access and/or use one or more functions, processes, procedures, data structures, classes, and/or other services provided by implementation instructions 1200 of system 1210. For example, API-calling instructions 1180 can access a feature of implementation instructions 1200 through one or more API calls or invocations (e.g., embodied by a function or a process call) exposed by API 1290 and can pass data and/or control information using one or more parameters via the API calls or invocations. In some embodiments, API 1290 allows application 1160 to use a service provided by a Software Development Kit (SDK) library. In some embodiments, application 1160 incorporates a call to a function or process provided by the SDK library and provided by API 1290 or uses data types or objects defined in the SDK library and provided by API 1290. In some embodiments, API-calling instructions 1180 makes an API call via API 1290 to access and use a feature of implementation instructions 1200 that is specified by API 1290. In such embodiments, implementation instructions 1200 can return a value via API 1290 to API-calling instructions 1180 in response to the API call. The value can report to application 1160 the capabilities or state of a hardware component of device 1150, including those related to aspects such as input capabilities and state, output capabilities and state, processing capability, power state, storage capacity and state, and/or communications capability. In some embodiments, API 1290 is implemented in part by firmware, microcode, or other low level logic that executes in part on the hardware component.

In some embodiments, API 1290 allows a developer of API-calling instructions 1180 (which can be a third-party developer) to leverage a feature provided by implementation instructions 1200. In such embodiments, there can be one or more set of API-calling instructions (e.g., including API-calling instructions 1180) that communicate with implementation instructions 1200. In some embodiments, API 1290 allows multiple sets of API-calling instructions written in different programming languages to communicate with implementation instructions 1200 (e.g., API 1290 can include features for translating calls and returns between implementation instructions 1200 and API-calling instructions 1180) while API 1290 is implemented in terms of a specific programming language. In some embodiments, API-calling instructions 1180 calls APIs from different providers such as a set of APIs from an OS provider, another set of APIs from a plug-in provider, and/or another set of APIs from another provider (e.g., the provider of a software library) or creator of the another set of APIs.

Examples of API 1290 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, an aggregated activity API, a prompt API, a speech generator API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 1150. For example, the sensor API can provide access to raw sensor data. For another example, the sensor API can provide data derived (and/or generated) from the raw sensor data. In some embodiments, the sensor data includes temperature data, image data, video data, audio data, heart rate data, steps data, blood oxygen data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 1200 is a system (e.g., operating system, server system) software module (e.g., a collection of computer-readable instructions) that is constructed to perform an operation in response to receiving an API call via API 1290. In some embodiments, implementation instructions 1200 is constructed to provide an API response (via API 1290) as a result of processing an API call. By way of example, implementation instructions 1200 and API-calling instructions 1180 can each be any one of an operating system, a library, a device driver, an API, an application program, or other module. It should be understood that implementation instructions 1200 and API-calling instructions 1180 can be the same or different type of software module from each other. In some embodiments, implementation instructions 1200 is embodied at least in part in firmware, microcode, or other hardware logic.

In some embodiments, implementation instructions 1200 returns a value through API 1290 in response to an API call from API-calling instructions 1180. While API 1290 defines the syntax and result of an API call (e.g., how to invoke the API call and what the API call does), API 1290 might not reveal how implementation instructions 1200 accomplishes the function specified by the API call. Various API calls are transferred via the one or more application programming interfaces between API-calling instructions 1180 and implementation instructions 1200. Transferring the API calls can include issuing, initiating, invoking, calling, receiving, returning, and/or responding to the function calls or messages. In other words, transferring can describe actions by either of API-calling instructions 1180 or implementation instructions 1200. In some embodiments, a function call or other invocation of API 1290 sends and/or receives one or more parameters through a parameter list or other structure.

In some embodiments, implementation instructions 1200 provides more than one API, each providing a different view of or with different aspects of functionality implemented by implementation instructions 1200. For example, one API of implementation instructions 1200 can provide a first set of functions and can be exposed to third party developers, and another API of implementation instructions 1200 can be hidden (e.g., not exposed) and provide a subset of the first set of functions and also provide another set of functions, such as testing or debugging functions which are not in the first set of functions. In some embodiments, implementation instructions 1200 calls one or more other components via an underlying API and thus be both a set of API calling instructions and a set of implementation instructions. It should be recognized that implementation instructions 1200 can include additional functions, processes, classes, data structures, and/or other features that are not specified through API 1290 and are not available to API-calling instructions 1180. It should also be recognized that API-calling instructions 1180 can be on the same system as implementation instructions 1200 or can be located remotely and access implementation instructions 1200 using API 1290 over a network. In some embodiments, implementation instructions 1200, API 1290, and/or API-calling instructions 1180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, a process 700 (FIG. 7) and/or a process 800 (FIG. 8) is performed at a first computer system (as described herein) via a system process (e.g., an operating system process, a server system process) that is different from one or more applications executing and/or installed on the first computer system.

In some embodiments, a process 700 (FIG. 7) and/or a process 800 (FIG. 8) is performed at a first computer system (as described herein) by an application that is different from a system process. In some embodiments, the instructions of the application, when executed, control the first computer system to perform process 700 (FIG. 7) and/or process 800 (FIG. 8) by calling an application programming interface (API) provided by the system process. In some embodiments, the application performs at least a portion of process 700 (FIG. 7) and/or process 800 (FIG. 8) without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a camera application, a chat application, a messaging application, and/or a maps application.

In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform process 700 (FIG. 7) and/or process 800 (FIG. 8) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, processes, procedures, data structures, classes, and/or other services provided by a set of implementation instructions of the system process. The API can define one or more parameters that are passed between the API calling instructions and the implementation instructions.

As described above, in some embodiments, the application controls the first computer system to perform a process 700 (FIG. 7) and/or a process 800 (FIG. 8) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a VisionKit API (e.g., for extracting text from an image), a pre-computing and pre-caching API, a prompt generator API, a speech generator API, a location detection API, a locator API, a maps API, a health sensor API, a sensor API, a messaging API, a push notification API, a video conferencing API, an application store API, an advertising services API, a web browser API (e.g., WebKit API), a networking API, a WiFi API, a Bluetooth API, an NFC API, a UWB API, a fitness API, a smart home API, contact transfer API, a photos API, a camera API, and/or an image processing API.

In some embodiments, the API 1290 defines a first API call that can be provided by API-calling instructions 1180, wherein the definition for the first API call specifies the call parameters (e.g., live and/or historical activity data, aggregated activity results, a prompt, or a prompt response).

In some embodiments, the API 1290 defines a first API call response that can be provided to the application by API-calling instructions 1180, wherein the first API call response includes aggregated activity results, a prompt, or a prompt response.

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., 1150) that runs the application. In some embodiments, the set of implementation instructions is included in an electronic device that is separate from the device that runs the application.

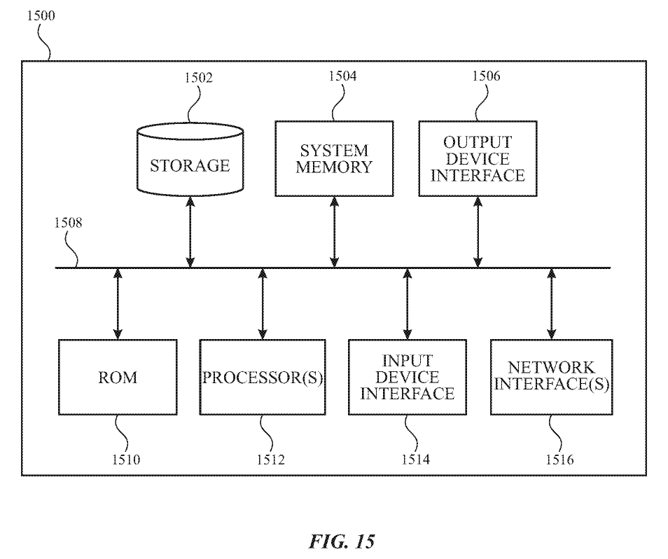

FIG. 15 illustrates an electronic system 1500 with which one or more implementations of the subject technology may be implemented. The electronic system 1500 can be, and/or can be a part of, one or more of the electronic device 104, the electronic device 110, and/or the server 120 shown in FIG. 1, and/or the device 200 of FIG. 2. The electronic system 1500 may include various types of computer readable media and interfaces for various other types of computer readable media. The electronic system 1500 includes a bus 1508, one or more processing unit(s) 1512, a system memory 1504 (and/or buffer), a ROM 1510, a permanent storage device 1502, an input device interface 1514, an output device interface 1506, and one or more network interfaces 1516, or subsets and variations thereof.

The bus 1508 collectively represents all system, peripheral, and chipset buses that communicatively connect the numerous internal devices of the electronic system 1500. In one or more implementations, the bus 1508 communicatively connects the one or more processing unit(s) 1512 with the ROM 1510, the system memory 1504, and the permanent storage device 1502. From these various memory units, the one or more processing unit(s) 1512 retrieves instructions to execute and data to process in order to execute the processes of the subject disclosure. The one or more processing unit(s) 1512 can be a single processor or a multi-core processor in different implementations.

The ROM 1510 stores static data and instructions that are needed by the one or more processing unit(s) 1512 and other modules of the electronic system 1500. The permanent storage device 1502, on the other hand, may be a read-and-write memory device. The permanent storage device 1502 may be a non-volatile memory unit that stores instructions and data even when the electronic system 1500 is off. In one or more implementations, a mass-storage device (such as a magnetic or optical disk and its corresponding disk drive) may be used as the permanent storage device 1502.

In one or more implementations, a removable storage device (such as a floppy disk, flash drive, and its corresponding disk drive) may be used as the permanent storage device 1502. Like the permanent storage device 1502, the system memory 1504 may be a read-and-write memory device. However, unlike the permanent storage device 1502, the system memory 1504 may be a volatile read-and-write memory, such as random access memory. The system memory 1504 may store any of the instructions and data that one or more processing unit(s) 1512 may need at runtime. In one or more implementations, the processes of the subject disclosure are stored in the system memory 1504, the permanent storage device 1502, and/or the ROM 1510. From these various memory units, the one or more processing unit(s) 1512 retrieves instructions to execute and data to process in order to execute the processes of one or more implementations.

The bus 1508 also connects to the input and output device interfaces 1514 and 1506. The input device interface 1514 enables a user to communicate information and select commands to the electronic system 1500. Input devices that may be used with the input device interface 1514 may include, for example, alphanumeric keyboards and pointing devices (also called “cursor control devices”). The output device interface 1506 may enable, for example, the display of images generated by electronic system 1500. Output devices that may be used with the output device interface 1506 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 15, the bus 1508 also couples the electronic system 1500 to one or more networks and/or to one or more network nodes, such as the server 120 shown in FIG. 1, through the one or more network interface(s) 1516. In this manner, the electronic system 1500 can be a part of a network of computers (such as a LAN, a wide area network (“WAN”), or an Intranet, or a network of networks, such as the Internet. Any or all components of the electronic system 1500 can be used in conjunction with the subject disclosure.

Implementations within the scope of the present disclosure can be partially or entirely realized using a tangible computer-readable storage medium (or multiple tangible computer-readable storage media

of one or more types) encoding one or more computer-readable instructions. It should be recognized that computer-executable instructions can be organized in any format, including applications, widgets, processes, software, software modules and/or components. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions

in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, processes, and algorithms described herein may be implemented as electronic hardware, computer software, or combinations of both. To illustrate this interchangeability of hardware and software, various illustrative blocks, modules, elements, components, processes, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a process claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded

the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
obtaining, by a portable electronic device, fitness information associated with a user of the portable electronic device;
generating, by the portable electronic device based on the fitness information, one or more sets of aggregated fitness results for one or more respective user interface features of the portable electronic device;
generating, by the portable electronic device, a prompt for a large language model, the prompt comprising human-language prompt text, in prose, and a context embedded in the human-language prompt text, the context corresponding to one of the one or more sets of aggregated fitness results for one of the one or more respective user interface features;
receiving, at the portable electronic device, a human-language response, in prose, to the prompt from the large language model; and
generating, by the portable electronic device using the one of the one or more respective user interface features, an output corresponding to the human-language response from the large language model.

2. The method of claim 1, wherein the one of the one or more respective user interface features comprises an audio user interface feature, and wherein the output comprises an audio output from a speaker of the portable electronic device, the audio output comprising a computer-generated verbalization of the human-language response, in prose, from the large language model.

3. The method of claim 2, wherein the computer-generated verbalization is generated in a computer-generated voice that comprises one or more voice characteristics of a voice of a specific human fitness trainer that is associated with the user of the portable electronic device.

4. The method of claim 1, wherein the fitness information comprises live fitness data being generated by a sensor of the portable electronic device during performance of an activity by the user, wherein the one of the one or more sets of the aggregated fitness results comprises at least some of the live fitness data, and wherein generating the prompt comprises generating the prompt responsive to an event associated with at least one of the activity or the live fitness data.

5. The method of claim 4, wherein the event comprises a start of the activity, an end of the activity, or a milestone event in the live fitness data.

6. The method of claim 5, wherein the one of the one or more sets of the aggregated fitness results further comprises historical fitness data for the user, wherein the event comprises the milestone event in the live fitness data, and wherein the human-language response to the prompt from the large language model comprises a congratulatory message corresponding to the milestone event.

7. The method of claim 6, further comprising:
generating, by the portable electronic device responsive to a subsequent milestone event in the live fitness data, a subsequent prompt for the large language model, the subsequent prompt comprising additional human-language prompt text and an updated context, corresponding to the one of the one or more sets of aggregated fitness results for the one of the one or more respective user interface features, embedded in the additional human-language prompt text;
receiving, at the portable electronic device, a subsequent human-language response to the subsequent prompt from the large language model, wherein the subsequent human-language response includes text corresponding to the milestone event and the subsequent milestone event; and
generating, by the portable electronic device using the one of the one or more respective user interface features, a subsequent output corresponding to the subsequent human-language response from the large language model.

8. The method of claim 4, wherein the one of the one or more sets of aggregated fitness results further comprises an indicator of media content output by the portable electronic device or another device of the user during the activity, and wherein the human-language response to the prompt from the large language model comprises text corresponding to the event and the media content.

9. The method of claim 4, wherein generating the one or more sets of aggregated fitness results for the one or more respective user interface features of the portable electronic device comprises periodically generating the one or more sets of aggregated fitness results for the one or more respective user interface features of the portable electronic device.

10. The method of claim 1, further comprising:
providing the prompt to a companion device for transmission to a server storing the large language model; and
receiving the human-language response from the companion device.

11. The method of claim 10, wherein the portable electronic device comprises a smart watch and wherein the companion device comprises a smartphone.

12. The method of claim 1, wherein the one of the one or more respective user interface features comprises a user interface of a fitness application for display by a display of the portable electronic device, and wherein the output comprises displayed text corresponding to the human-language response from the large language model in the user interface of the fitness application.

13. The method of claim 12, wherein the fitness information comprises historical fitness information for the user over a first period of time, and wherein the human-language response from the large language model comprises text that refers to one or more fitness achievements of the user within a second period of time shorter than the first period of time.

14. A portable electronic device, comprising:
a memory; and
one or more processors configured to:
obtain activity information associated with a user of the portable electronic device;
generate, based on the activity information, one or more sets of aggregated activity results for one or more respective user interface features of the portable electronic device;
generate a prompt for a machine learning model that has been trained to generate prose responses to prose prompts, the prompt comprising prompt text, in prose, and a context embedded in the prompt text, the context corresponding to one of the one or more sets of aggregated activity results for one of the one or more respective user interface features;
receive, at the portable electronic device, a response, in prose, to the prompt from the machine learning model; and
generate, by the portable electronic device using the one of the one or more respective user interface features, an output corresponding to the response from the machine learning model.

15. The portable electronic device of claim 14, further comprising a speaker, wherein the one of the one or more respective user interface features comprises an audio user interface feature, and wherein the output comprises an audio output from the speaker, the audio output comprising a computer-generated verbalization of the response, in prose, from the machine learning model.

16. The portable electronic device of claim 14, further comprising a sensor, wherein the activity information comprises activity data being generated by the sensor during performance of an activity by the user, wherein the one of the one or more sets of the aggregated activity results comprises at least some of the activity data, and wherein generating the prompt comprises generating the prompt responsive to an event associated with at least one of the activity or the activity data.

17. The portable electronic device of claim 16, wherein the event comprises a start of the activity, an end of the activity, or a milestone event in the activity data.

18. The portable electronic device of claim 17, wherein the one of the one or more sets of the aggregated activity results further comprises historical activity data for the user, wherein the event comprises the milestone event in the activity data, and wherein the response to the prompt from the machine learning model comprises a congratulatory message corresponding to the milestone event.

19. The portable electronic device of claim 18, wherein the one or more processors are further configured to:
generate, responsive to a subsequent milestone event in the activity data, a subsequent prompt, in prose, for the machine learning model, the subsequent prompt comprising additional prompt text and an updated context, corresponding to the one of the one or more sets of aggregated activity results for the one of the one or more respective user interface features, embedded in the additional prompt text;
receive a subsequent response, in prose from the machine learning model, to the subsequent prompt, wherein the subsequent response includes text corresponding to the milestone event and the subsequent milestone event; and
generate, using the one of the one or more respective user interface features, a subsequent output corresponding to the subsequent response from the machine learning model.

20. A computer readable medium storing instructions of an application for controlling an electronic device to perform a process, the process comprising:
obtaining, by a portable electronic device, fitness information associated with a user of the portable electronic device;
generating, by the portable electronic device based on the fitness information, one or more sets of aggregated fitness results for one or more respective user interface features of the portable electronic device;
generating, by the portable electronic device, a prompt for a large language model, the prompt comprising human-language prompt text, and a context embedded in the human-language prompt text, the context corresponding to one of the one or more sets of aggregated fitness results for one of the one or more respective user interface features;
receiving, at the portable electronic device, a human-language response to the prompt from the large language model; and
generating, by the portable electronic device using the one of the one or more respective user interface features, an output corresponding to the human-language response from the large language model.

21. A method, comprising:
receiving, by a first device from a second device, a prompt for a large language model, the prompt comprising human-language prompt text, in prose, and an activity data context embedded in the human-language prompt text;
providing the prompt from the first device to a server hosting the large language model;
receiving, at the first device from the server, a human-language response, in prose, to the prompt from the large language model;
generating, by the first device, a computer-generated verbalization of the human-language response; and
providing, from the first device to the second device, an audio signal corresponding to the computer-generated verbalization for output by a speaker of the second device.

22. The method of claim 21, wherein the activity data context corresponds to one of one or more sets of aggregated fitness results for one of one or more respective user interface features at the second device.

23. The method of claim 22, wherein the aggregated fitness results are based on real-time sensor data obtained by one or more sensor of the second device immediately before the receiving of the prompt, and wherein the method further comprises, by the first device:
generating an other prompt, in prose, for the large language model, the other prompt comprising additional prompt text and an other context that is based on historical activity data at the first device, the other context corresponding to an other set of aggregated activity results for a user interface feature at the first device, embedded in the additional prompt text;
providing the other prompt to the server;
receiving an other response, in prose from the large language model, to the other prompt; and
generating, using the user interface feature at the first device, an other output corresponding to the other response from the large language model.
